(19) United States
(12) Patent Application Publication
(10) Pub. No.: US 2026/0109382 A1
(43) Pub. Date: Apr. 23, 2026

(54) Laundry Cart Assembly

(71) Applicant: Royal Basket Trucks, Inc., Darien, WI (US)

(72) Inventors: Brian Albrecht, Elkhorn, WI (US); Paharo Orr, Wauwatosa, WI (US); Thomas E. Carney, Darien, WI (US); Cynthia Lapidakis, Delavan, WI (US); William David Falcon, Elkhorn, WI (US)

(21) Appl. No.: 19/359,991

(22) Filed: Oct. 16, 2025

Related U.S. Application Data
(60) Provisional application No. 63/708,300, filed on Oct. 17, 2024.

(51) Int. Cl. B62B 3/00; B62B 3/02

(52) U.S. Cl. CPC B62B 3/005; B62B 3/02; B62B 2202/66

(57) ABSTRACT

A rollable cart assembly usable for transporting cloth goods such and laundry and linens and that is defined by a tub and a plurality of shelves that can be removed from the tub in multiple respective directions and cooperate with the tub in respective generally horizontal and/or vertical orientations. The tub defines multiple cut outs that facilitate respective shelves being removed from, or associated with, the tub in a generally forward horizontal direction or a generally upward vertical direction when desired. Each shelf preferably includes a reinforcement that mitigates deformation of the respective shelves when loaded. A base of the tub is preferably constructed to facilitate selective evacuation or drainage of liquids introduced to the tub.

### CROSS REFERENCE TO RELATED PATENTS

This application claims priority to U.S. Provisional Patent Application Ser. No. 63/708,300 filed on Oct. 17, 2024 titled “Laundry Cart Assembly” and the disclosure of which is incorporated herein.

### FIELD OF THE INVENTION

The present invention relates generally to transport cart assemblies, and more particularly, to a portable laundry cart assembly having at least one moveable and/or removable shelf and, in a preferred aspect, is defined at least in part by a drainable tub.

### BACKGROUND OF THE INVENTION

Many environments employ the use of transport carts to effectuate convenient transport of goods and consumables throughout various environments. Hospitality, educational, and medical environments commonly employ many rolling transport devices that are commonly uniquely constructed and/or configured to improve efficiency associated with interaction and use of the respective transport cart assemblies and/or the goods and/or materials being transported therewith within the respective service environments. One such application includes the provision of laundry carts that are constructed to communicate soiled and clean fabric goods such as clothing, uniforms, linens, sheets, towels and the like between laundry service areas and areas or locations associated with use of the discrete fabric goods—such as rooms, suites, locker rooms, pool areas, etc. Such laundry carts are commonly used by service personnel to transport soiled goods from the use areas to the laundry facilities as well as transport cleaned goods to the respective use areas. Many such carts include discrete movable features, such as doors and/or removable trays or shelves to provide discrete configurations of the laundry cart to satisfy the demands associated with the use of such carts. While the adjustability of the configuration of such laundry cart assemblies proves advantageous or desirous for many users, such features can prove unsuitable or detrimental to the desired use of the discrete cart assemblies during endeavors or activities.

Many laundry carts are provided with moveable and/or removable shelves that are configured to accommodate the desired use of the cart to transport the alternate clean or soiled laundry goods. Many such carts are also commonly provided with a substantially open front facing side to accommodate convenient interaction with the cart assemblies by the respective laundry service personnel. When employed for the collection of soiled laundry, some such carts include removable or foldable shelves such that entirety of the tub defined by the cart can be employed for the collection of soiled launderable goods. Known laundry transport carts are not without their respective drawbacks.

When employed for the return of laundered and folded goods, some such carts which are equipped with removable shelves require the respective shelves be wholly reassociated with the cavity defined by the tub after each use as a laundry collection tub and to mitigate over compression or compaction of clean and folded goods disposed in the lower portions of the tub. Laundry carts which allow removal of the discrete shelves require the user to raise and lower the discrete shelves in a generally vertical direction to achieve the desired positional association of the shelves relative to the tub during placement and removal of the shelves. Such translations can prove challenging or arduous for shorter and/or less physically capable and/or agile staff members.

In an effort to mitigate the physicality associated with the repeated association and/or removability of the discrete shelves from the laundry transport cart tub, others provide laundry transport cart assemblies having light weight shelves. Such attempts have received limited market success as the shelves are constructed in manners that lead to deflection and/or unintended dissociation of the shelves from the respective supporting structures defined by the tub during normal use of the respective transport cart assembly.

Still other laundry transport carts are susceptible to uses that interfere with the use of the cart assemblies for transport of soiled laundry as well as subsequent use of the cart assembly for transport of cleaned and folded cloth articles. For instance, during use for collection of soiled cloth articles, housekeeping or other staff personnel may inadvertently or intentionally associate over soiled or wetted materials or liquids to the transport cart assembly during cleaning operations. Collection of water or other liquids within the perimeter of the tub assembly must be addressed or resolved prior to subsequent use of the cart assembly to transport cleaned materials lest any residual liquids soil recently cleaned goods associated with an insufficiently cleaned cart previously used for the collection of soiled cloth materials or goods.

Accordingly, there is a need to provide a laundry cart assembly that is constructed to accommodate rolling transport of the cart and goods associated therewith, has a robust construction that accommodates expedient placement and/or removal of one or more shelves with the underlying tub, and accommodates drainage of fluids that may have been associated with the laundry cart assembly during previous uses thereof.

### SUMMARY OF THE INVENTION

The present invention provides numerous advantages over the prior art. The present invention provides a rolling laundry cart assembly that includes a tub and multiple shelves that can be selectively associated with the tub in various support positions and/or orientations and which can be associated with or removed from the tub in various directions and/or relative orientations. The laundry cart assembly is further preferably constructed to collect and drain liquids that may have been associated with the laundry cart prior to use of the cart for transport of cleaned laundry goods.

One aspect of the present invention discloses a laundry cart assembly that includes a tub that is defined by a base, a pair of side walls, a back wall that extends upwardly from the base. A carriage having a plurality of casters is attached to an underside of the base and facilitates rollable transport of the laundry cart assembly. The assembly includes at least one shelf that is constructed to cooperate with the tub such that the shelf extends between the pair of side walls. An extraction slot is formed in a forward-facing edge of each of the pair of side walls such that the shelf can be translated in a forward direction during association with or removal of the shelf from the tub.

Another aspect of the invention that is usable or combinable with one or more of the above aspects, objects, or features discloses a laundry cart assembly that includes a tub that is defined by a base and a first side wall and a second side wall that intersect a rear wall such that the first side wall, the second side wall, and the rear wall extend upwardly from the base. At least one shelf cooperates with the tub and is constructed to be selectively supported in each of a generally horizontal position and a generally vertical position relative to the tub. A first cut out and a second cut out are formed in a respective one of the first side wall and the second side wall and constructed to allow the shelf to be extracted from the tub via translation in a forward direction relative thereto. A chassis cooperates with the base of the tub and has a plurality of casters that are associated therewith. A basin is defined by the base and is pitched or sloped toward a drain wherein the basin and the drain are oriented inboard of the chassis and shaped to facilitate drainage of liquids from the laundry cart assembly.

A further aspect of the present invention that is usable or combinable with one or more of the above aspects, features, or objects discloses a method of forming a laundry cart assembly. A tub is formed that defines a base, a pair of side walls, a back wall, and an open front. A chassis is formed and has a plurality of casters and is constructed to be secured to an underside of the base of the tub. A shelf is formed that removably cooperates with the tub and a plurality of cut outs are formed in each of the pair of side walls of the tub so that the shelf can be removed from the tub in either of a forward direction or an upward or vertical direction.

These and other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications. Other features, objects, aspects, and advantages of the invention are made apparent from the following description taken together with the drawings. It is further appreciated that the various features, aspects, objects, and advantages disclosed above are not mutually exclusive to the specific aspects of the invention such that the various discrete features, aspects, objects, and advantages are usable and/or combinable with one another.

### DESCRIPTION OF THE DRAWINGS

The drawings illustrate the best mode presently contemplated of carrying out the invention.

In the drawings:

FIG. 1 is a perspective view of a laundry cart assembly according to the present invention;

FIG. 2 is a front elevation view of the laundry cart assembly shown in FIG. 1;

FIG. 3 is a top plan view of the laundry cart assembly shown in FIG. 1 with the plurality of shelves associated therewith;

FIG. 4 is a view similar to FIG. 3 of the laundry cart shown in FIG. 1 with the discrete shelves removed therefrom;

FIG. 5 is a cross section view of the laundry cart assembly shown in FIG. 1 taken along line 5-5 shown in FIG. 2;

FIG. 6 is a cross section view of a lower portion of the laundry cart assembly shown in FIG. 1 taken along line 6-6 shown in FIG. 3;

FIG. 7 is a perspective view of a chassis of the laundry cart assembly shown in FIG. 1;

FIG. 8 is a perspective view of the laundry cart assembly shown in FIG. 1 with the shelves removed therefrom;

FIG. 9 is a perspective view of one of the shelves shown in FIG. 8;

FIG. 10 is an elevation view of the shelf shown in FIG. 9;

FIG. 11 is a cross section elevation view of the shelf shown in FIG. 9 taken along line 5-5 shown in FIG. 2;

FIG. 12 is a perspective view of the laundry cart assembly similar to FIG. 1 with the shelves being slideably associated with the tub assembly in a forward lateral direction;

FIG. 13 is a perspective view of the laundry cart assembly shown to FIG. 1 with the shelves being oriented in a generally vertical orientation relative to the tub thereof; and

FIG. 14 is a view of the laundry cart assembly shown in FIG. 13 with one of the shelves between vertically translated relative to the tub thereof.

Various aspects of the invention are described in detail with reference to the drawings, wherein like reference numerals, including the reference numeral designations, represent like parts and assemblies throughout the several views. Reference to one embodiment does not limit the scope of the claims attached hereto. Additionally, any examples set forth in this specification are not intended to be limiting and merely set forth some of the many possible embodiments for the appended detailed description and claims.

### DETAILED DESCRIPTION OF THE PREFERRED EMBODIMENT

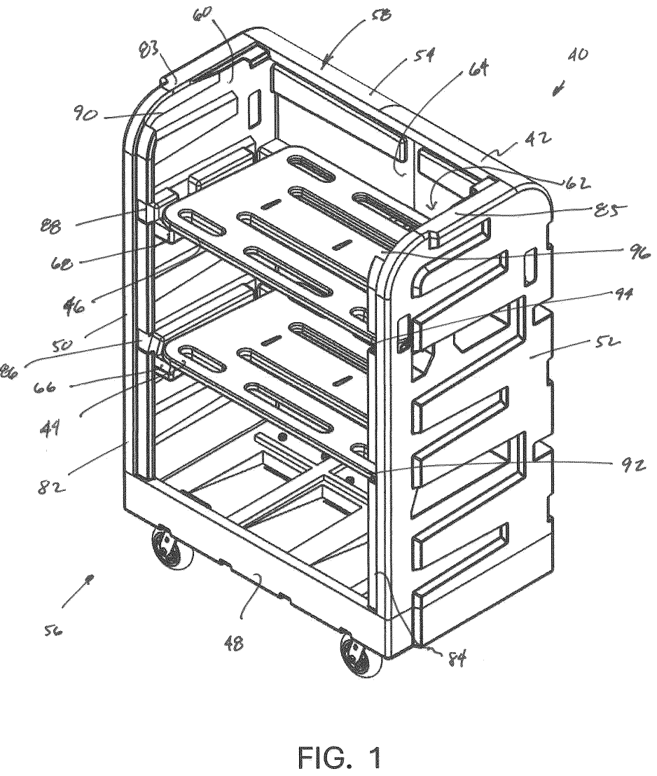

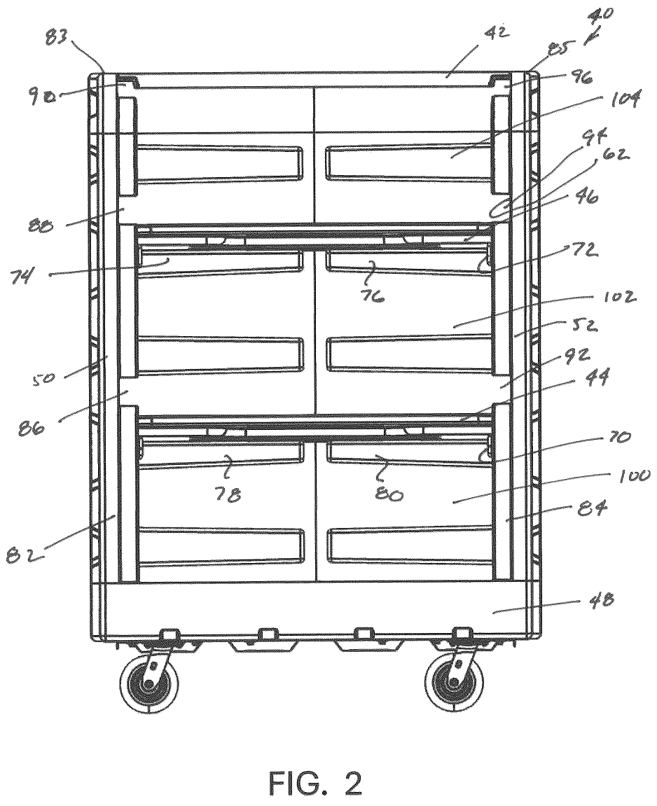

This application discloses a laundry cart assembly and a method of providing or forming such a laundry cart assembly 40 that overcomes one or more of the drawbacks disclosed above. FIGS. 1 and 2 show a laundry cart assembly 40 according to the present invention with respective shelves associated therewith oriented in a first position relative to a tub 42 associated therewith. Laundry cart assembly 40 includes tub 42 that is constructed to receive one or more shelves 44, 46 that, as disclosed in further detail below, cooperate with tub 42 in various orientations and which can be placed and/or removed from tub 42 in various modalities. Tub 42 is generally defined by a bottom portion or base 48, a first side wall 50, a second side wall 52, and a rear or back wall 54. Tub 42 generally defines a generally front or forward facing opening 56 and a generally upward or top facing opening 58 that are defined by the respective upwardly extending cooperation of side walls 50, 52 and back wall 54 with base 48.

Inwardly facing surfaces 60, 62 of side walls 50, 52 and an inward facing surface 64 of back wall 54 each include one or more bosses 66, 68, 70, 72, 74, 76, 78, 80 that are constructed and oriented to support respective shelves 44, 46 when respective shelves 44, 46 are engaged with tub 42 and oriented in a generally horizontal position or a shelf orientation as shown in FIGS. 1 and 2. When oriented in the configuration shown in FIGS. 1 and 2, laundry cart assembly can be employed for the distribution of cleaned and folded cloth or linen goods without undue or undesirable compression of the goods were shelves 44, 46 omitted. A forward-facing edge 82, 84 and an upward-facing edge 83, 85 of each of side walls 50, 52 includes one or more cutouts 86, 88, 90, 92, 94, 96 that are shaped to slideably cooperate with respective shelves 44, 46 during placement and/or removal of the respective shelves 44, 46 relative to tub 42 when desired.

When shelves 44, 46 are generally horizontally associated with tub 42, laundry cart assembly 40 is configured to provide a first goods cavity 100 that is generally between base 48 and shelf 44, a second goods cavity 102 that is generally between first shelf 44 and second shelf 46, and a third goods cavity 104 that is generally above shelf 46. The discrete goods cavities 100, 102, 104 mitigate over compression of clean and/or folded linen or cloth goods that are transported with laundry cart assembly 40 during use thereof and which may be disposed in the lower respective portions or goods cavities 100, 102 thereof.

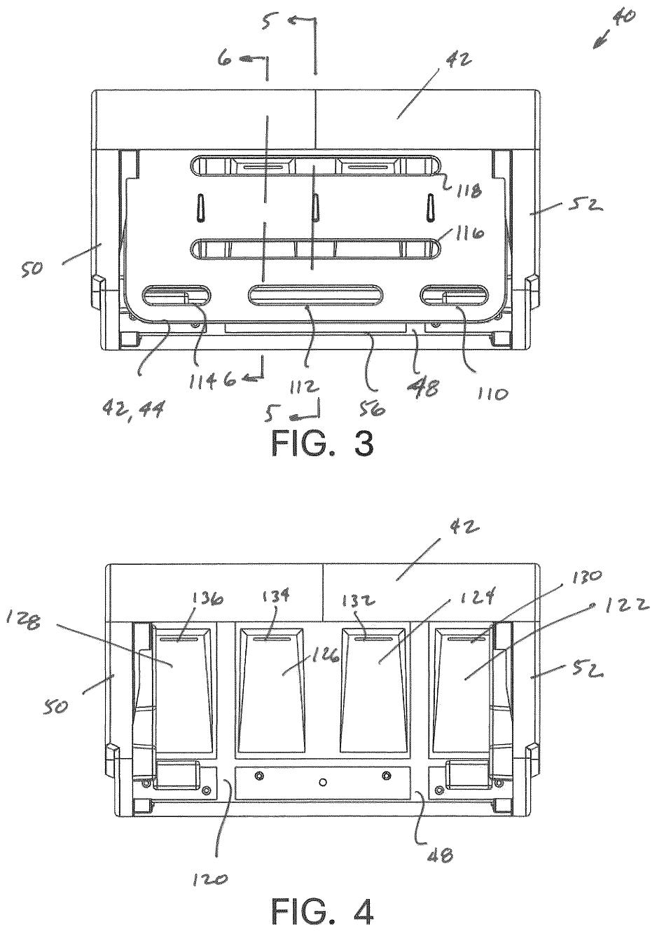

Referring to FIG. 3, when shelves 42, 44 are associated with tub 42 and oriented in the generally horizontal position, shelves 42, 44 generally vertically overlie one another. Each shelf 44, 46 includes one or more grasp locations, hand holds, or handles 110, 112, 114 that are disposed proximate opening 56 of tub 42. Handles 110, 112, 114 are constructed and oriented to allow convenient user interaction with each of the discrete shelves 44, 46 when removal or placement of shelves 44, 46 relative to tub 42 is desired. One or more passages 116, 118 are formed through shelves 44, 46 and reduce the weight thereof. FIG. 4 is a top plan view of laundry cart assembly 40 with shelves 42, 44 removed from tub 42 and thereby exposing the upwardly or inwardly directed surface 120 of base 48. As disclosed further below, base 48 defines one or more catchment areas or basins 122, 124, 126, 128. Each basin 122, 124, 126, 128 includes a drain 130, 132, 134, 136 that passes through base 48 and allows the egress of any liquids that may have been associated with assembly 40 from the confines of tub 42 and base 48. Basins 122, 124, 126, 128 are contoured to direct liquids deposited thereon toward drains 130, 132, 134, 136 and therefrom beyond the confines of tub 42.

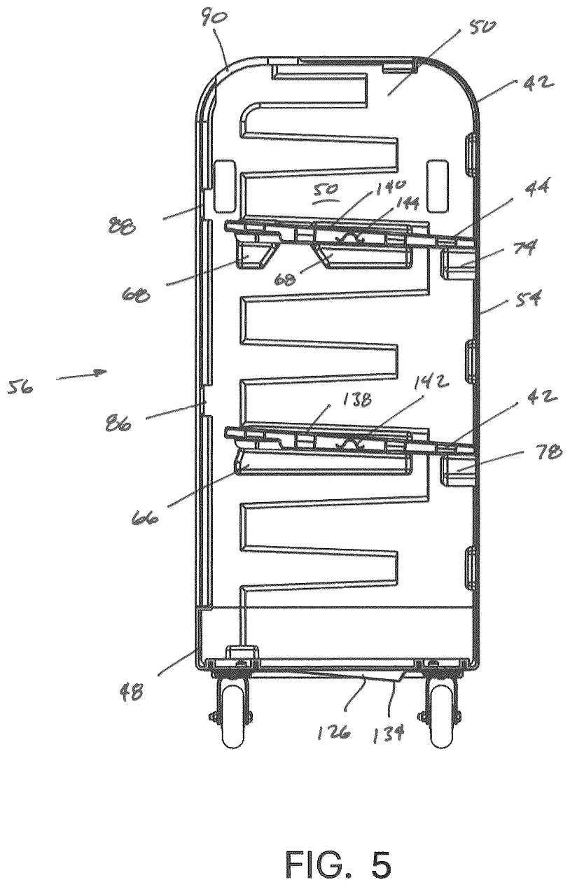

Referring to FIGS. 2 and 5, when shelves 42, 44 are associated with tub 42 and oriented in the generally horizontal orientation, respective shelves 42, 44 are supported by respective bosses 66, 68 defined by sidewall 50; bosses 70, 72 defined by sidewall 52; and bosses 74, 78 defined by rear wall 54. As shown in FIG. 5, when oriented in the generally horizontal orientation relative to tub 42, at least an upper surface 138, 140 of each of shelves 42, 44 is pitched in a downward and rearward direction as the respective shelves 42, 44 extend away from opening 56 and toward rear wall 54 of tub 42. Such a consideration encourages goods disposed upon shelves 42, 44 toward rear wall 54 and/or away from opening 56 associated with the forward-facing side of tub 42. Such a consideration encourages goods associated with shelves 44, 46 away from opening 56 and out of cart assembly 40 during use thereof and ensures the respective goods associated therewith maintain a desired supported association of the discrete goods with cart assembly 40 during transport thereof.

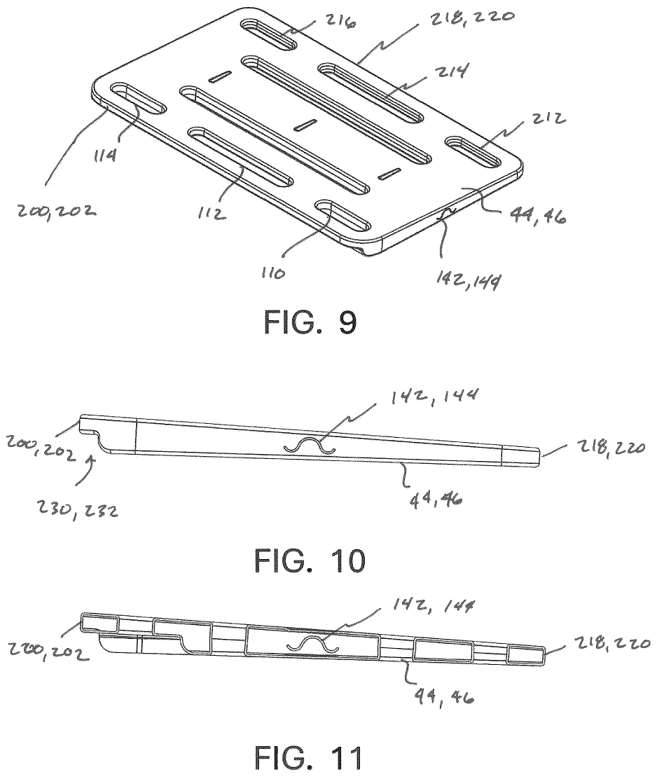

As disclosed further below with respect to FIGS. 9-11, each shelf 44, 46 includes a brace, gusset, or reinforcement 142, 144 that is preferably internal to and extends in a longitudinal direction along each shelf 44, 46. Each reinforcement 142, 144 is positioned such that, when the respective shelf 44, 46 is associated with tub 42 in the horizontal orientation, the respective reinforcement 142, 144 is disposed generally above the respective bosses 66, 68, 70, 72 defined by respective side walls 50, 52 of tub 42. Reinforcements 142, 144 are preferably constructed of a robust or rigid material and are constructed to mitigate deflection and/or deformation of shelves 42, 44 during use of laundry transport cart assembly 40 when goods are associated with the discrete shelves 44, 46 associated therewith.

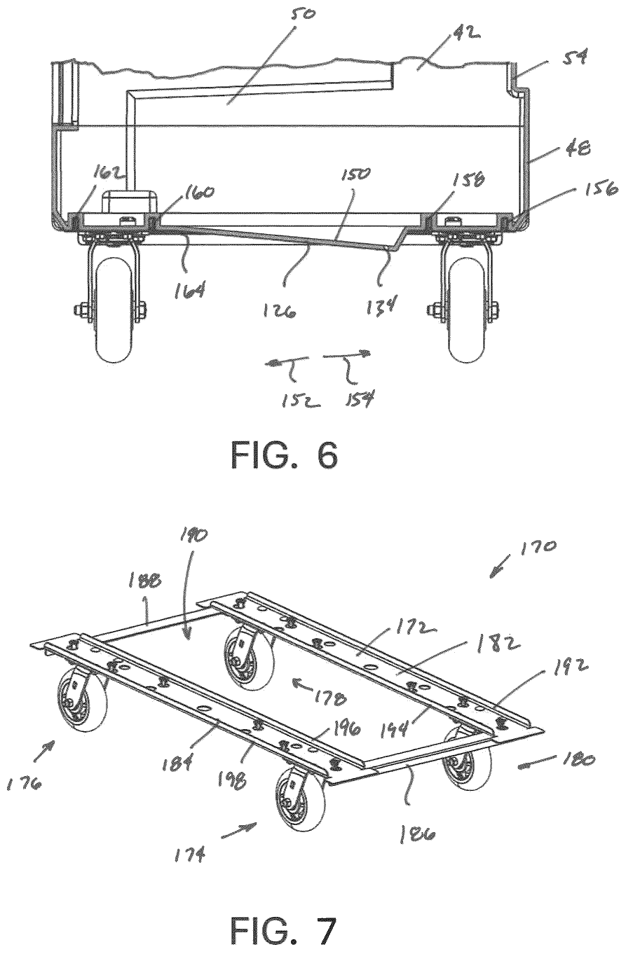

As shown in FIG. 6, each of basins 122, 124, 126, 128 is pitched toward a respective drain 130, 132, 134, 136 defined by base 48 of tub 42. Liquids associated with tub 42 impinge upon an upper surface 150 of a respective basin 126 and are directed toward a respective drain 134 such that the liquids can drain from tub 42. Laterally outboard, indicated by arrows 152, 154, of respective basins 126, base 48 defines one or more channels 156, 158, 160, 162 that extend in a longitudinal direction along an underside 164 of base 48. Referring to FIGS. 6 and 7, laundry cart assembly 40 includes a roller assembly 170 that is generally defined by a chassis 172 and a plurality of casters 174, 176, 178, 180 that are secured to chassis 172. Roller assembly 170 facilitates rollable transport of laundry cart assembly 40 when chassis 172 is secured to the underside of base 48 of tub 42.

Chassis 172 is generally defined by a first rail 182 and a second rail 184 that each extend in a longitudinal direction and a pair of respective lateral rails 186, 188 that connect opposing longitudinal ends of the first and second rails 182, 184. An open area 190 is defined by chassis 172 and generally bounded by rails of 182, 184, 186, 188. Open area 190 is constructed to accommodate basins 122, 124, 126, 128 when chassis 172 is secured to base 48 of tub 42. Each longitudinal rail 182, 184 includes opposing flanges 192, 194, 196, 198 that extend along an upwardly directed surface thereof. Respective flanges 192, 194, 196, 198 are constructed to cooperate with respective channels 156, 158, 160, 162 defined by the underside 164 of base 48 of tub 42.

When chassis 172 is secured to base 48 of tub 42, chassis 172 is oriented radially outboard of each of respective basins 126 defined by base 48. The cooperation of flanges 192, 194, 196, 198 of chassis 172 with respective channels 156, 158, 160, 162 of base 48 of tub 42 mitigates twisting and/or racking of chassis 172 relative to base 48 and provides a robust connection methodology therebetween. The construction and cooperation of chassis 172 with base 48 further effectuates efficient communication of the downward forces associated with loads associated with tub 42 to respective casters 174, 176, 178, 180 and does so in a manner that does not interfere with the liquid collection and draining functionality of basins 122, 124, 126, 128 and drains 130, 132, 134, 136 defined by base 48.

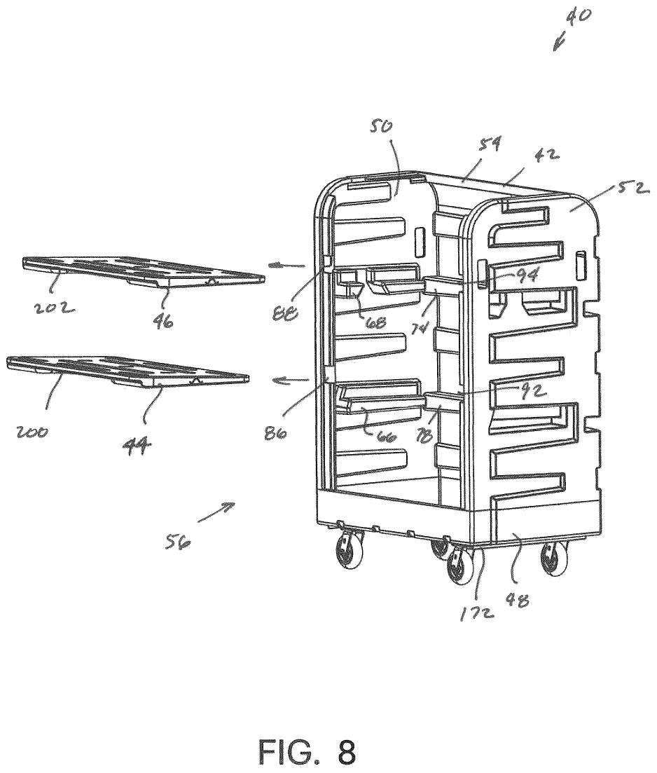

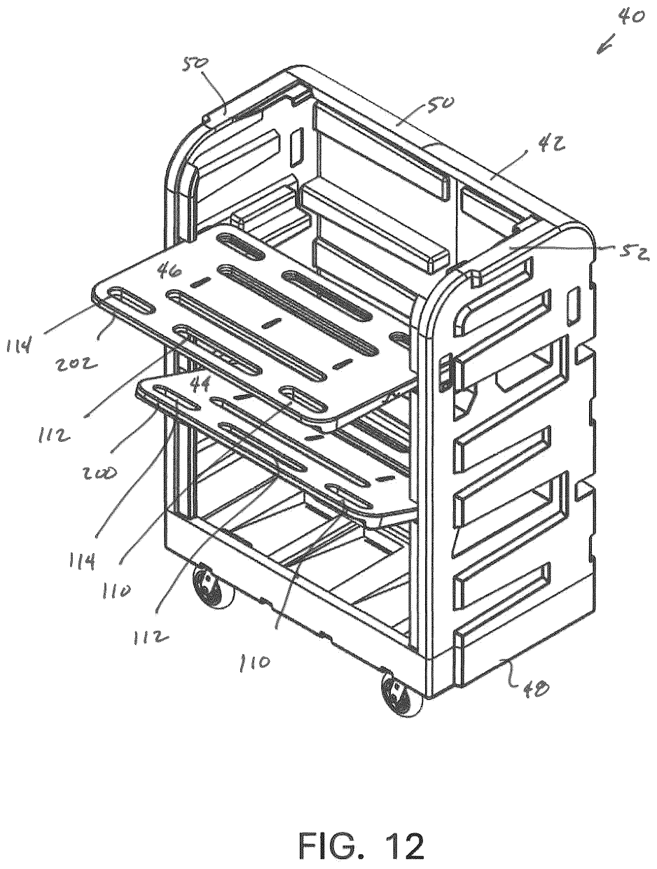

Referring to FIGS. 8 and 12, when removal or placement of shelves 44, 46 relative to tub 42 in a horizontal position or orientation is desired, shelves 44, 46 can be removed or associated with tub 42 via passage of respective shelves 44, 46 through the opening 56 associated with the forward-facing side of tub 42. During extraction of shelves 44, 46 via the forward facing opening 56, forward edge 200, 202 of respective shelves 44, 46 can be grasped by the user via one or more of handles 110, 112, 114; slightly inclined relative to respective bosses 66, 68; and slideably extracted from tub 42 via slidable cooperation of respective shelves 44, 46 with the corresponding extraction slot or channel or cutouts 86, 92 (associated with lower shelf 44) or the extraction slot or channel or cut outs 88, 94 (associated with upper shelf 46).

Reassociation of shelves 44, 46 with tub 42 can be efficiently accommodated via rearward slidable cooperation of respective shelves 44, 46 with the corresponding respective cutouts 86, 88, 92, 94 until the rearward edge of respective shelves 44, 46 abuts rear wall 54 of tub 42 and whereby the respective shelf 44, 46 simply drops into engagement with the respective bosses 66, 68, 70, 72 defined by the respective sidewalls 50, 52. When supported by the respective bosses 66, 68, 70, 72, the respective shelves 44, 46 are supported in an orientation wherein the planar shape of the respective shelf 44, 46 is maintained at an orientation wherein the discrete shelf 44, 46 is slightly out of vertical alignment with the corresponding cutouts 86, 88, 92, 94 defined by sidewalls 50, 52. Such a consideration mitigates unintentional or inadvertent dissociation of shelves 44, 46 from tub 42 when shelves 44, 46 are horizontally oriented. That is, extraction or removal of shelves 44, 46 from tub 42 requires user interaction to slightly raise the outward facing leading edge of shelves 44, 46 in a slightly upward direction to effectuate the slidable cooperation of respective shelves 44, 46 with the respective aligned cutouts 86, 88, 92, 94 to effectuate the horizontal dissociation of horizontally oriented shelves 44, 46 from tub 42.

As alluded to above and referring to FIGS. 9-11, each shelf 44, 46 has the same construction such that shelves 44, 46 can cooperate with tub 42 in either of the upper or lower horizontal shelf positions or orientations disclosed above. One or more handles 110, 112, 114, and/or additional handles 212, 214, 216 are formed along the generally opposite longitudinal edges 200, 202, 218, 220 of each shelf 44, 46 and accommodate convenient user interaction therewith. Preferably each shelf 44, 46 is constructed via an injection molded, blow molded, and/or rotomolding operation to have a generally hollow construction and are constructed from plastic type materials. As shown in FIGS. 10 and 11, the reinforcement 142, 144 associated with each shelf 44, 46 extends the longitudinal length of each respective shelf 44, 46 and has a generally non-planar, and preferably serpentine, cross-sectional shape. Reinforcements 142, 144 are also preferably generally centrally disposed along the lateral center line of respective shelves 44, 46. The non-planar construction of respective reinforcements 142, 144 further improves the rigidity of respective shelves 44, 46. In a preferred aspect, reinforcements 142, 144 can be constructed of plastic, fiber reinforced, and/or metal materials such that reinforcements 142, 144 exhibit a negligible elasticity or are otherwise non-deformable under normal conditions of use of cart assembly 40.

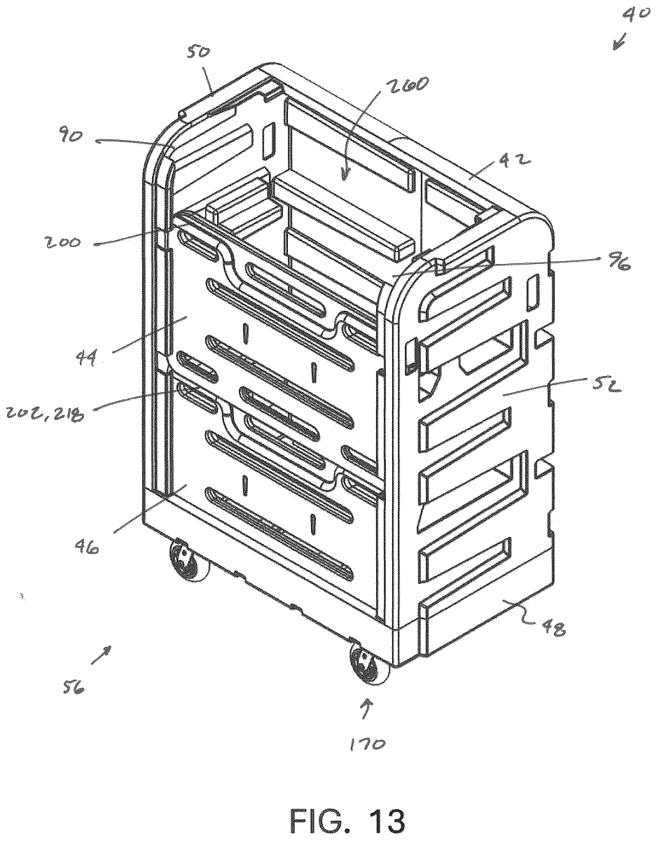

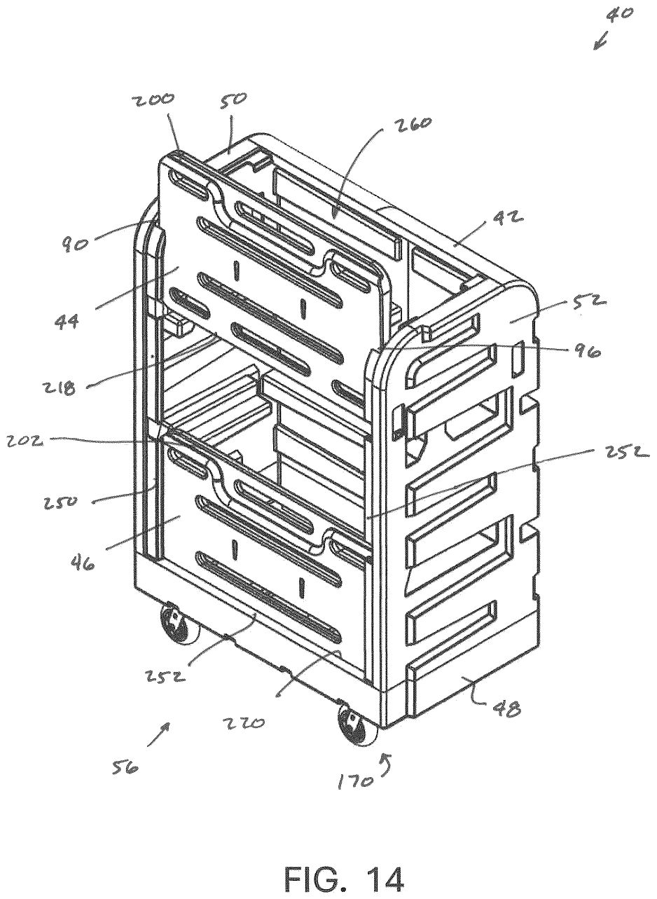

Referring to FIGS. 10 and 11, respective edges 200, 202 of respective shelves 44, 46 include a notch 230, 232 and a thickness that is slightly larger than a thickness of edges 218, 220. As disclosed further below with respect to FIG. 13, shelves 44, 46 can cooperate with tub 42 in a generally vertical, or vertically stacked, orientation to obstruct a substantial portion of opening 56 of the forward-facing side of tub 42. As shown in FIGS. 13 and 14, when it is not desired and/or necessary to transport goods with laundry cart assembly 40 having shelves 44, 46 oriented in the horizontal orientation, shelves 44, 46 can cooperate with tub 42 in a vertical orientation such that shelves 44, 46 overlie at least a portion of the forward-facing opening 56 defined by tub 42 and thereby enclose incremental portions of the cavity of the tub of cart assembly 40.

To achieve the vertical orientation of shelves 44, 46 relative to tub 42, a first shelf 44, 46 is associated with respective extraction channel or slot or cutouts 90, 96 defined near the top edges of respective sidewalls 50, 52 and displaced in a generally downward direction between respective bosses 66, 68, 70, 72 and a forward and laterally inward extending flange 250, 252 defined by respective sidewalls 50, 52. Respective edge 220 of lower shelf 46 can rest upon and/or be restrained by a forward facing edge of base 48 when positioned thereagainst. Upwardly oriented edge 202 of lower vertically oriented shelf 46 cooperates with edge 218 of upper vertically oriented shelf 44 and effectuates vertical and lateral alignment therewith.

Each of shelves 44, 46 pass slideably through cutouts 90, 96 associated with respect to sidewalls 50, 52 in a sequential manner to achieve the generally vertical stacked orientation of shelfs 44, 46 relative to tub 42 as shown in FIGS. 13 and 14. When oriented in such a manner, laundry cart assembly 40 provides a configuration wherein soiled cloth and/or linen goods can be generally disposed in the cavity 260 defined by tub 42 and the vertically oriented and stacked shelves 44, 46 engage therewith. As with the horizontal orientation of shelves 44, 46, when shelves 44, 46 are oriented in the vertically stacked orientation as shown in FIGS. 13 and 14, reinforcements 142, 144 prevent outward lateral deflection of respective shelves 44, 46 relative to tub 42 and mitigate unintended or undesired dissociation of shelves 44, 46 from tub 42 when shelves 44, 46 are oriented in the vertical and stacked orientation as shown in FIG. 13.

Laundry cart assembly 40 is constructed to provide various configurations wherein various shelves can be associated with a tub assembly in either of a vertical orientation such that the shelves define a boundary of the laundry cart assembly and a horizontal orientation wherein the shelves divide the internal areas of the laundry cart assembly into discrete goods cavities. The various shelves and tub of laundry cart assembly 40 are constructed to accommodate either generally horizontal or generally vertical placement and removal of the discrete shelves from the tub such that laundry cart assembly 40 can be quickly, conveniently, and intuitively converted between configurations suitable for distribution of cleaned goods and collection of soiled goods. Laundry cart assembly 40 is further constructed to mitigate the retention of liquids within the laundry cart assembly and is instead constructed to collect and drain liquids therefrom.

Therefore, one embodiment of the present invention a laundry cart assembly having a tub that is defined by a base, a pair of side walls, a back wall that extends upwardly from the base. A carriage having a plurality of casters is attached to an underside of the base and facilitates rollable transport of the laundry cart assembly. The assembly includes at least one shelf that is constructed to cooperate with the tub such that the shelf extends between the pair of side walls. An extraction slot is formed in a forward-facing edge of each of the pair of side walls such that the shelf can be translated in a forward direction during association with or removal of the shelf from the tub when desired.

Another embodiment of the invention that is usable or combinable with one or more of the above aspects, objects, features, or embodiments includes a laundry cart assembly having a tub that is defined by a base and a first side wall and a second side wall that intersect a rear wall such that the first side wall, the second side wall, and the rear wall extend upwardly from the base. At least one shelf cooperates with the tub and is constructed to be selectively supported in each of a generally horizontal position and a generally vertical position relative to the tub. A first cut out and a second cut out are formed in a respective one of the first side wall and the second side wall and are constructed to allow the shelf to be extracted from the tub via translation in a forward direction relative thereto. A chassis cooperates with the base of the tub and has a plurality of casters that are associated therewith. A basin is defined by the base and is pitched or sloped toward a drain wherein the basin and the drain are oriented inboard of the chassis and shaped to facilitate drainage of liquids from the laundry cart assembly.

A further embodiment of the invention that is usable or combinable with one or more of the above aspects, features, objects, or embodiments includes a method of forming a laundry cart assembly. The method includes forming a tub that defines a base, a pair of side walls, a back wall, and an open front. A chassis is formed and has a plurality of casters and is constructed to be secured to an underside of the base of the tub. A shelf is formed that removably cooperates with the tub and a plurality of cut outs are formed in each of the pair of side walls of the tub so that the shelf can be removed from the tub in either of a forward direction or an upward or vertical direction.

These and other aspects, objects, features, embodiments, and advantages of the invention will become apparent to those skilled in the art from the following claims. It should be understood, however, that the detailed description and the specific examples provided therein, while indicating preferred embodiments of the present invention, are given by way of illustration and not of limitation. Many changes and modifications may be made within the scope of the present invention without departing from the spirit thereof, and the invention includes all such modifications. Other features, objects, aspects, and advantages of the invention made apparent from the above description taken together with the drawings. It is further appreciated that the various features, aspects, objects, and advantages disclosed above are not mutually exclusive to the specific aspects of the invention such that the various discrete features, aspects, objects, and advantages are usable and/or combinable with others.

We claim:

1. A laundry cart assembly comprising:
a tub defined by a base and a pair of side walls and a back wall that extend upwardly from the base;
a carriage having a plurality of casters and attached to an underside of the base;
at least one shelf constructed to cooperate with the tub such that the at least one shelf extends between the pair of side walls; and
an extraction slot formed in a forward facing edge of each of the pair of side walls such that the at least one shelf can be translated in a forward direction to be associated with or removed from the tub.

2. The laundry cart assembly of claim 1 further comprising another extraction slot formed in the forward facing edge of each of the pair of side walls at a location offset from the extraction slot.

3. The laundry cart assembly of claim 2 further comprising another shelf constructed to cooperate with the tub at a location that is offset from the at least one shelf and such that the another shelf is generally aligned with the another extraction slot.

4. The laundry cart assembly of claim 3 wherein the at least one shelf and the another shelf are interchangeable.

5. The laundry cart assembly of claim 4 further comprising a further extraction slot that is located generally above the extraction slot and the another extraction slot such that the at least one shelf and the another shelf can be removed from the tub via translation of a respective at least one shelf and another shelf in a vertical direction and through the further extraction slot.

6. The laundry cart assembly of claim 1 wherein the at least one shelf can be retained in a vertical position relative to the tub to overlie a forward facing opening flanked by the pair of side walls.

7. The laundry cart assembly of claim 1 further comprising a reinforcement that extends along a longitudinal length of the at least one shelf and is enclosed therein.

8. The laundry cart assembly of claim 1 further comprising a catchment area formed in the base of the tub.

9. The laundry cart assembly of claim 1 further comprising a plurality of hand-holds formed in the at least one shelf.

10. A laundry cart assembly comprising:
a tub defined by a base and a first side wall and a second side wall that intersect a rear wall such that the first side wall, the second side wall, and the rear wall extend upwardly from the base;
at least one shelf that cooperates with the tub and is constructed to be supported in a generally horizontal position and a generally vertical position relative to the tub;
a first cut out and a second cut out formed in a respective one of the first side wall and the second side wall and constructed to allow the at least one shelf to be extracted from the tub via translation in a forward direction;
a chassis constructed to cooperate with the base of the tub;
a plurality of casters associated with the chassis; and
a basin defined by the base and pitched toward a drain wherein the basin and the drain are oriented inboard of the chassis.

11. The laundry cart assembly of claim 10 wherein the at least one shelf is further defined as a first shelf and a second shelf and wherein the first shelf and the second shelf have the same construction and are each constructed to cooperate with the tub at locations that are vertically offset from one another.

12. The laundry cart assembly of claim 11 further comprising a third cut out and a fourth cut out formed in a respective one of the first side wall and the second side wall and oriented to allow the second shelf to be extracted from the tub via translation in a forward direction.

13. The laundry cart assembly of claim 12 further comprising a fifth cut out and a sixth cut out formed in a respective one of the first side wall and the second side wall and oriented to allow a respective one of the first shelf and second shelf to be extracted from the tub via vertical translation of the respective shelf relative thereto.

14. The laundry cart assembly of claim 10 wherein the at least one shelf further comprises a reinforcement that extends along a longitudinal length of the at least one shelf and is contained by the at least one shelf.

15. The laundry cart assembly of claim 14 wherein the reinforcement has a cross-section shape that resists bending of the reinforcement.

16. A method of forming a laundry cart assembly, the method comprising:
forming a tub that defines a base, a pair of side walls, a back wall, and an open front;
forming a chassis having a plurality of casters and that is constructed to be secured to an underside of the base of the tub;
forming a shelf that removably cooperates with the tub;
forming a plurality of cut outs in each of the pair of side walls of the tub so that the shelf can be removed from the tub in either of a forward direction or an upward direction.

17. The method of claim 16 wherein forming the shelf further comprises forming a reinforcement that extends along a longitudinal length of the shelf.

18. The method of claim 16 further comprising providing at least two shelves having the same construction.

19. The method of claim 16 further comprising forming at least one basin in the base of the tub and terminating the basin at a drain positioned inboard of the chassis.

20. The method of claim 16 further comprising forming the tub such that the shelf can be supported in a generally horizontal position and a generally vertical position that overlies a portion of the open front of the tub when the shelf is oriented in the generally vertical position.
